(19) United States
(12) Patent Application Publication
(10) Pub. No.: US 2009/0119156 A1
(43) Pub. Date: May 7, 2009

(54) SYSTEMS AND METHODS OF PROVIDING MARKET ANALYTICS FOR A BRAND

(75) Inventor: Rajiv Dulepet, West Hills, CA (US)

Correspondence Address: FISH & ASSOCIATES, PC;ROBERT D. FISH, 2603 Main Street, Suite 1000, Irvine, CA, 92614-6232, US

(73) Assignee: WISE WINDOW INC., Santa Monica, CA (US)

(21) Appl. No.: 12/253,541

(22) Filed: Oct. 17, 2008

Related U.S. Application Data
(60) Provisional application No. 60/985,052, filed on Nov. 2, 2007.

(51) Int. Cl. G06F 17/30

(52) U.S. Cl. 705/10

(57) ABSTRACT

Methods for providing marketing analytics are presented. Information about a brand is extracted from web documents using a search program. The search program learns about how a brand is referenced from the context of one or more web documents having quality, quantity, or entity brand characteristics. After learning about the brand, the program extracts information from additional web documents especially those having the quality, quantity, and entity characteristics. As the program analyzes the documents, it stores the extracted information in a database to build a statically significant data set.

This application claims the benefit of priority to U.S. provisional application having Ser. No. 60/985,052, filed on Nov. 2, 2007. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is market analysis.

### BACKGROUND

Companies conduct market research to understand how their brands are received by a target market. However, market researches find it difficult to find real-time buzz information associated with their brand or sentiment that consumers have for researcher's brand of interest.

Several companies attempt to provide real-time analysis tools for researching market buzz or sentiment information by scouring web sites; looking for relevant information. Example existing companies offering such services include Umbria®, Nielsen BuzzMetrics®, BuzzLogic®, TNS Cymfony, and Motive Quest. These and other services require a user to define initial search parameters to begin crawling the Web for buzz or sentiment. Unfortunately, such an approach forces the resulting data to conform to the researches pre-conceived notions of the buzz or the sentiment that they expect, thereby rendering the data skewed, or worse, useless. For example, a researcher could elect to search for sentiment associated with their product described by the term “great” and find many web sites that stating their product is “great”. However, they would likely miss other references that have terms that are not commonly associated with “great” including “superlative,” “phat,” “GR8” (“GR8” is short hand for “great” in text messaging, instant messaging, or other real-time communications) or other potential synonyms. Thus, the resulting data set is skewed and does not properly reflect the sentiment associated with their product.

Ideally a market research solution would review documents learn about the brand characteristics including quality, ratings, or products and then extract information associated with the brand for analysis without allowing a researcher to shape the data even before conducting an analysis. The extracted information would then be unbiased and used to gather buzz or sentiment statistics across numerous other documents.

Thus, there is still a need for providing market analytics where information can be extracted in an unbiased manner from brand characteristics and stored in a database for analysis by a researcher.

### SUMMARY OF THE INVENTION

The present invention provides apparatus, systems and methods in which brand information is collected and presented to a user for analysis.

In one embodiment brand information is extracted from web documents referencing brand characteristics, preferably quality, quantity, or entity characteristics. The characteristics can be used to learn about the brand and can be used as guidance to extract information associated with the brand from other web documents. The resulting extracted information is stored in a database for later analysis through provided analysis tools. In preferred embodiments, extract brand information stored in the database includes an entity, an attribute, or a sentiment.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a graphical tag cloud displaying over developed and under developed positives and negatives.

FIG. 2 is a schematic of a graphical bubble chart comparing attributes with respect to their relative statistical significances.

FIG. 3 is a schematic of a trend chart using sentiment of various products as a function of time.

FIG. 4 is a schematic of graphical tag cloud showing an issue map using confidence levels.

FIG. 5 is a schematic of a horizontal bar chart showing the buzz of several terms using relative statistical significances.

FIG. 6 is a schematic of method of providing marketing analytics.

### DETAILED DESCRIPTION

Market researchers use marketing analytics to research how people perceive their brand within the market. Two areas of interest to researchers when researching a brand include the buzz surrounding the brand and the sentiment that the market has toward the brand.

Within the context of this document, the term “brand” means a trademark or service mark, whether registered or not. In some cases a brand could be the name or image of a person, but not a person per se.

The term “buzz” means the quantity of references associated with a target brand entity of interest. Buzz can be measured through the use of analysis tools indicate of how the buzz is affected by factors including time, geography, demographics, events, applied marketing effort, competitors, news, or other factors that can influence buzz. In some embodiments, buzz includes a rate, a relative value, a buzz density, or other measurement derived from the quantity of references. Researchers find buzz useful when attempting to detect the impact of marketing efforts on their brand.

The term “sentiment” means the general perception held by the market toward the brand. Sentiment can represent a full spectrum of perceptions from deeply negative to deeply positive. For example, the buzz surrounding a target brand entity could indicate a generally positive sentiment while the buzz surrounding a second target brand entity could indicate a generally negative sentiment. In a preferred embodiment, sentiment comprises a score that could be an absolute value or relative value. An absolute sentiment value can simply be a number on a scale. A relative sentiment value represents the difference between the sentiments of two target entities.

Before a researcher can begin researching the buzz or the sentiment related to their target brand entity, the research requires access to a data set, preferably a database, having compiled sentiment, entity, or attribute information. In a preferred embodiment, the database is compiled by crawling web documents and extracting the desired information from the documents.

Web documents include any document that can be accessed via a search program. Example web documents include text documents, images, pod-casts, videos, audio files, programs, instant messages, text messages, or other electronic documents. Preferred web documents are opinion-based documents including reviews, blogs, forum posts, or other documents where opinions are cited.

In the preferred embodiment, a search program crawls through web documents to compile buzz or sentiment data. The search program learns about a target brand entity by analyzing a first set of documents to understand how the target brand entity is referenced in the market in general. Preferably, the search program identifies documents having three brand characteristics including an entity characteristic, a quality characteristic, or a quantity characteristic. These and other characteristics are typically represented by words, phrases, numbers, or other analyzable quanta.

An entity characteristic includes data associated with the target brand entity having direct references to the target brand entity or an indirect reference to the target brand entity. A direct reference represents a match between literal strings, keywords, terms, or other tags. Indirect references are those references that are inferred from analyzing the web documents. For example, when crawling through web documents for “TV” the search program infers that references to “boob tube” or “monitor” indirectly refers to “TV”. Additionally, an entity characteristic can include attributes associated with the target brand entity. To continue the TV example, attributes could include “contrast”, “brightness”, “resolution”, or “cable-ready”. A search program automatically sifts through the information in the web documents to correlate any entity characteristic with the target brand entity. Since the search program is free from an initial bias it freely discovers additional statically relevant entity characteristic phrases that might not have been discovered otherwise. For example, the program can discover that an abbreviation, an acronym, other phrases, or other entity characteristic strongly correlates with the target brand entity. The correlation can be done through building statistics around the number of occurrences that an entity characteristic is encountered within the web documents. The entity characteristic provides a foundation for determining the buzz associated with a brand.

A quality characteristic represents a foundational element for sentiment and includes information about the perception of a target brand entity as indicated by the web documents. Quality characteristics include words, phrases, or other indications that the perception is positive or negative. The quality characteristics are generally human understandable, but not necessarily computer understandable. To illustrate this point consider the previous TV example. A first web document could contain a reference to the TV stating the “TV has a great picture.” In this example, “great” represents a positive quality characteristic, but does not necessarily equate to a quantifiable value to a computer. “Great” could also be used in a negative manner as in “this TV is a great waste of time”. Although quality characteristics do not necessarily provide a quantifiable reference by themselves, they can form the basis of a quantifiable sentiment when combined with quantity characteristics. Preferably a search program analyzes the web document to determine which words, phrases, or combination of references correlate to quality characteristics.

A quantity characteristic includes information that can be quantified by a computer program. Typical quantity characteristics found within web documents include ratings, number of citations, or other indication of a value. Some quality characteristics are inferred from information within the web documents where a subjective scale is presented. Consider web documents that list a spectrum of information from “Strongly disagree” to “Strongly agree” with eight steps between the two. Such a scale can be contextually reduced to a value or number; one through 10 in this case. Other quantity characteristics are simply references to a number; a number of stars associated with a movie rating for example.

In a preferred embodiment, the search program starts with a first set of web documents to convert the quality, quantity, and entity characteristics to extracted information associated with the target brand entity or brand. The various characteristics are compared against each other, preferably using a form of regression analysis, to determine which combinations of the characteristics have strong correlations. Buzz statistics are created based on the number of references to entities or attributes. Sentiment information is derived by equating the quality characteristics with the quantity characteristics within the same web documents. When the analysis has proceeded sufficiently, the search program then has an understanding for which entities to search in additional web documents, and how to derive sentiment from the additional documents. In the preferred embodiment, the search program begins with review documents that have all three characteristics to form an understanding of the brand information. Then additional web documents are searched to compile additional statistics and to learn more about the brand.

Information extracted from web documents includes entity references, attributes, or sentiment. As previously mentioned, entity references represent how web documents refer to the target brand entity or brand. Attributes include items associated with the entity and can include features, capabilities, limitations, advantages, disadvantages, or other associated information. Sentiment is derived from the quality and quantity characteristics. The resulting extracted information is stored in a database for retrieval and analysis.

In preferred embodiments, sentiment is assigned a score or other value. In the preferred embodiment, sentiment is measured on a scale from one to five; however, other non-numeric scales are also contemplated including opinion based scales.

It is contemplated that additional information is also stored in the database for use in analysis. Typical information includes date or time stamps, links to the web documents, authors, document types, citations, trustworthiness of the web documents, or other data associated with the web documents. It is also contemplated, that a researcher could specifically request specific additional types of data to be retained during the search.

As the search program continues its search for additional information, it crawls through a large number of web documents to build statistics associated with the information. As the search continues the program preferable over weights documents having the quality, quantity, and entity characteristics, however, it is not necessary to restrict the search to only those documents. In alternative embodiments the program also searches web documents having one or two of the characteristics, and in some cases, none of the three characteristics. Documents lacking brand characteristics are useful to establish a background comparison of brand information and can be used to indicate lack of buzz penetration into a marketing domain.

In some situations where data is readily available the information is obtained quickly in a matter of hours, minutes, or even seconds and the real-time information is supplied to the researcher. In other situations where information is not readily available, the information could be aggregated over days, weeks, or even months. In either case, the data is preferably provided to a researcher immediately upon availability even if a desired level of statistics has yet to be reached.

The preferred embodiment uses the collected information to derive a statistical significance associated with the brand information. The statistical significance includes a measure of the number of references of the information in the database where the significance can be an absolute value or a relative value. Absolute values are those significances having a raw number, 1 million references for example, and can be used to sort or rank occurrences of the extracted information. Relative values can be measured relative to a background or to other entries in the database. A background measure, similar to a density, indicates a number of “hits” in web documents relative to the total number of web documents searched and are useful when determining the penetration of buzz in various marketing domains. Relative statistical significances are useful when conducting competitive analysis or other research comparing brands.

In preferred embodiments software programs also derive relationships among the various entities, attributes, sentiments or other extracted information in the database as a function of the data collected by the search program. Preferred types of relationships include trends, relative statistical significances of buzz, sentiment, and attributes, over or underdeveloped positives and negatives, or confidence levels. Relationships are preferably presented to a researcher in a graphical form including a tag cloud, trend graph, bar chart or other form. In especially preferred embodiments a researcher can construct a desired graphical representation of the relationships.

The following figures illustrate possible embodiments of graphical representations of relative significances of various entities, relationships, and attributed derived from extracted information.

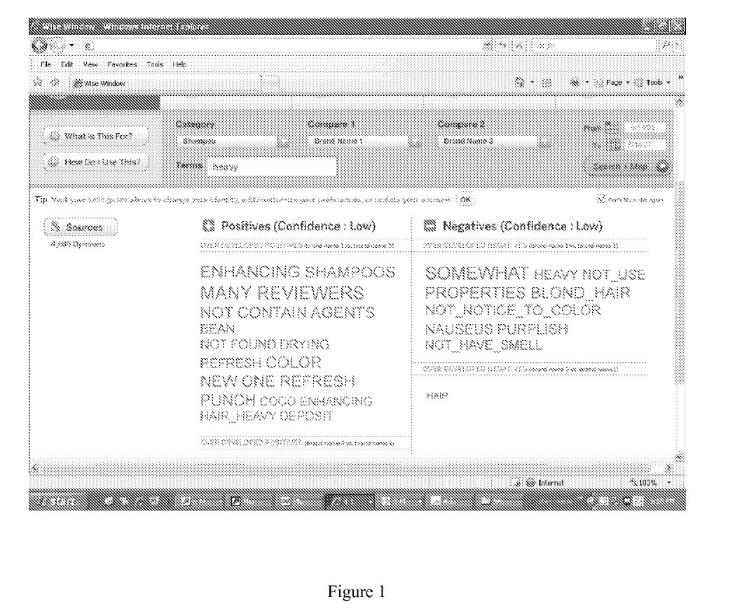

FIG. 1 is a schematic of a graphical tag cloud displaying over developed and under developed positives and negatives.

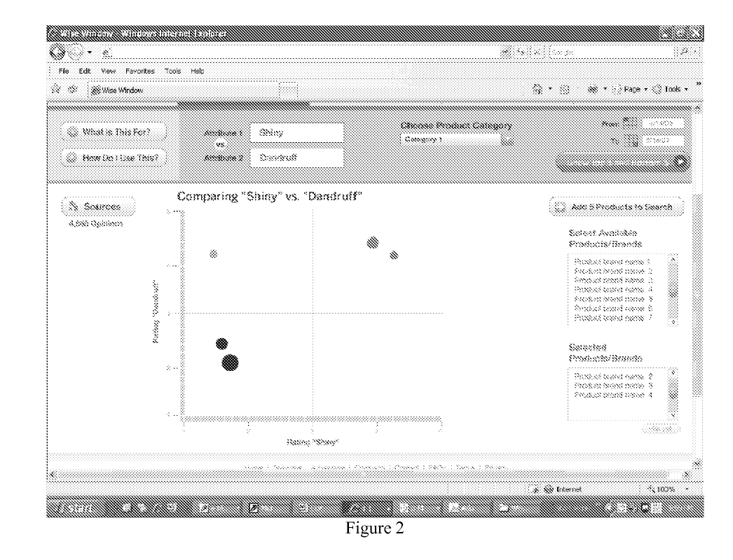

FIG. 2 is a schematic of a graphical bubble chart comparing attributes with respect to their relative statistical significances.

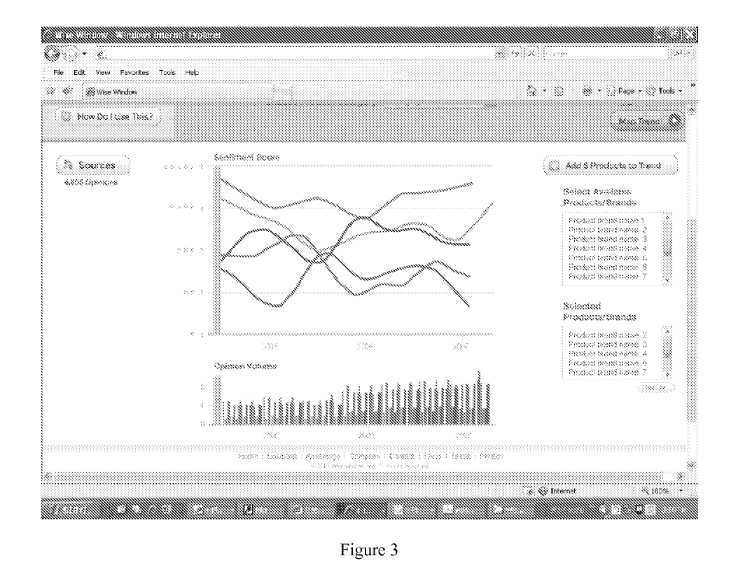

FIG. 3 is a schematic of a trend chart using sentiment of various products as a function of time.

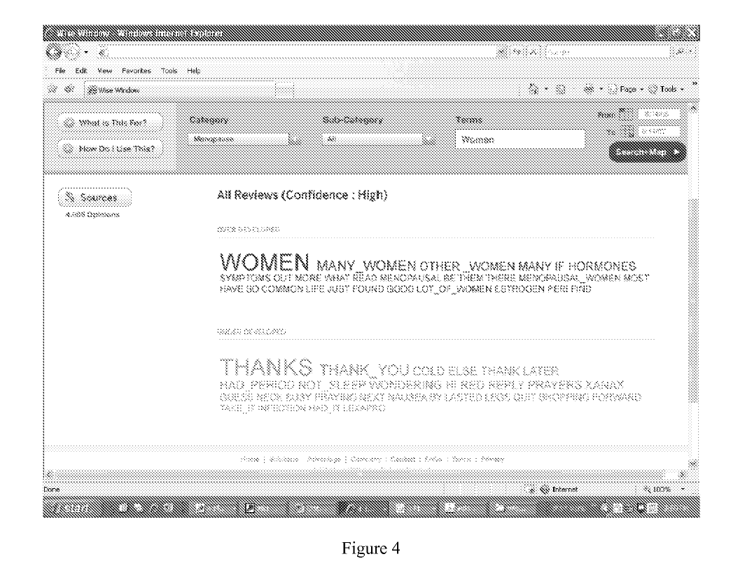

FIG. 4 is a schematic of graphical tag cloud showing an issue map using confidence levels.

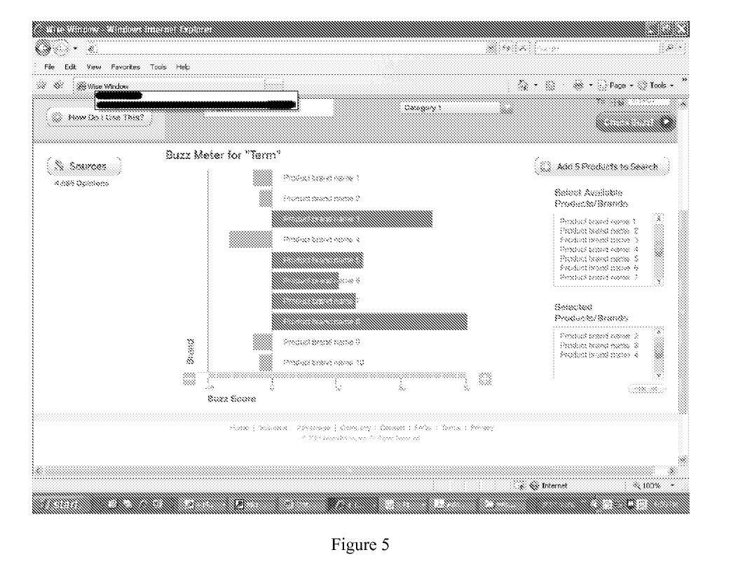

FIG. 5 is a schematic of a horizontal bar chart showing the buzz of several terms using relative statistical significances.

Researchers use one more provided analysis tools or utilities to map the buzz or the sentiment in a marketing domain using a desired format. As previously stated, graphical tools are one form of analysis tools. In addition, non graphical tools are also contemplated including spreadsheets, script engines, or other systems that provide for analyzing the data.

The preferred embodiment also provides for accessing raw data directly. As a researcher analyzes their data set, they are able to request a link to where the resulting information comes from and gain access to the derivation of sentiment, brand characteristics, or even the original web documents.

One should appreciate the advantages provided by the outlined approach. A researcher can analyze buzz or sentiment associated with any market including product marketing, movie reviews, personal presence (movie stars for example), or political campaigns.

Additionally, the data collected is generic with respect to the source material domain without being skewed by the researcher. A researcher will find that blogs will discuss a product differently than a technical review. The outlined approach will ensure each such domain is treated independently or internally consistent without bias while maintaining coverage across the markets. By treating each domain independently, the relative statistical significances or sentiments are domain specific ensuring the researcher obtains data without bias. For example, movie review sites might have positive sentiment about a movie while blogs have negative sentiment toward the movie, but both domain sources contribute to the buzz. Also, in both sources of information and their corresponding data are valuable to the researcher.

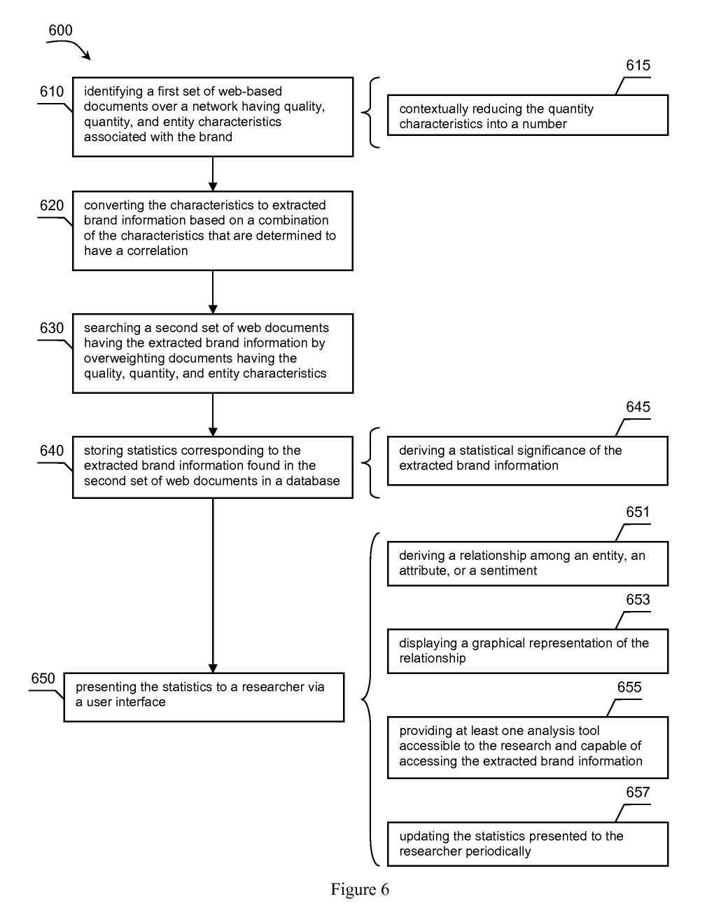

FIG. 6 presents method 600 for providing marketing analytics. In a preferred embodiment a research utilizes a computer-based system storing software instructions on a computer-readable media where the instructions substantially operate according to method 600.

At step 610 a first set of web-based documents are identified over a network, preferably the Internet, having various characteristics associated with a brand. Preferred characteristics include quality, quantity, or entity characteristics as previously discussed. In some embodiments, the various characteristics can contextually be reduced into a number at step 615 to ease analysis conducted by a researcher. It should be noted that the desirable characteristics can be found within the metadata of a document as well as the document's content.

The characteristics found in step 610 are collected and converted to extracted brand information (e.g., entity references, attributes, or sentiments) at step 620. The characteristic are converted to the extracted brand information by determining which combinations of characterizes have the strongest correlations. The correlation can be determined through regression analysis or other suitable algorithm. In a preferred embodiment, the correlations are determined automatically via a computer implemented method without requiring initial input from a researcher that could cause undesirable bias.

At step 630, additional web documents are searched, possibly by crawling the web over the Internet, for the extracted brand information. In a preferred embodiment, those additional web documents having all three of the preferred characteristics are overweigheted (e.g., analyzed as a higher priority) relative to those additional web documents having fewer interesting characteristics. In some embodiments, the additional web documents are searched or analyzed according to a priority determined from the number of preferred characteristics located within the document. Those web documents having a smaller number of characteristics, have less priority; and those having none of the characteristics would likely be analyzed last, if at all.

As the additional web documents are searched or analyzed, statistics corresponding to the extracted brand information can be stored within a database at step 640. The database provides a foundation from which a researcher can analyze a market for buzz or sentiment. In a preferred embodiment, the contemplated system also derives a statistical significance for the extracted brand information, which also can be stored in the database.

A research can access the database via one or more analysis tools or utilities at step 655 where preferably, at step 650 the system presents the collected statistics to the researched via user interface. At step 651 the analysis tools can aid the research in deriving relationships among the elements of the extracted brand information, including entity references, attributes, or sentiments. Furthermore the user interface can display the various relationships in a graphical form, possibly through web page as previously discussed with respect to FIGS. 1 through 5. In an especially preferred embodiment, the statistics presented to the researcher can be updated for, preferably periodically, at step 657. For example, one a research can define their desired analytical approach via the user interface, the system can crawl the Internet for additional statistics. The system can update any graphs, charts, spreadsheets, or other data presentations within a week's time, more preferably within a day's time, or even in near real-time (e.g., as the data is collected).

One skilled in the art should appreciate that the techniques disclosed are not limited to marketing analytics, but can also be applied to other areas where analytics are useful. For example, a heath care clinic could use the techniques to data mine their patient databases for interesting correlations between patients, among doctors, treated diseases for medical information.

It should be also apparent the data sources are not restricted only to web documents, but also any database source where quantity and quality information can be correlated. Other example database sources beyond web documents include customer support databases, or focus group results. An example use-case of non-web documents includes a product marketing researcher using sentiment derived from customer feedback data and correlating that sentiment to a database having returned product information.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of providing market analytics for a brand, the method comprising:
identifying a first set of web-based documents over a network having quality, quantity, and entity characteristics associated with the brand;
converting the characteristics to extracted brand information based on a combination of the characteristics that are determined to have a correlation;
searching a second set of web documents having the extracted brand information by overweighting documents having the quality, quantity, and entity characteristics;
storing statistics corresponding to the extracted brand information found in the second set of web documents in a database; and
presenting the statistics to a researcher via a user interface.

2. The method of claim 1, wherein the extracted brand information is an entity reference.

3. The method of claim 1, wherein the extracted brand information is an attribute.

4. The method of claim 1, wherein the extracted brand information is a sentiment.

5. The method of claim 1, further comprising contextually reducing the quantity characteristics into a number.

6. The method of claim 1, wherein the quantity characteristics is a number.

7. The method of claim 1, further comprising deriving a statistical significance of the extracted brand information.

8. The method of claim 1, further comprising deriving a relationship among an entity, an attribute, or a sentiment.

9. The method of claim 8, further comprising displaying a graphical representation of the relationship.

10. The method of claim 1, further comprising providing access to at least a portion of the second set of web documents.

11. The method of claim 1, wherein the first set of web documents includes a review.

12. The method of claim 1, further comprising providing at least one analysis tool accessible to the research and capable of accessing the extracted brand information.

13. The method of claim 1, wherein the user interface comprises a web interface.

14. The method of claim 13, wherein the web interface comprises a network accessible application program interface (API).

15. The method of claim 1, further comprising updating the statistics presented to the researcher within one week.

16. The method of claim 15, further comprising updating the statistics presented to the researcher within one day.

17. The method of claim 16, further comprising updating the statistics presented to the researcher in near real-time.
